(19) United States
(12) Patent Application Publication
(10) Pub. No.: US 2025/0202150 A1
(43) Pub. Date: Jun. 19, 2025

(54) CONNECTOR AND CONTACT MODULE

(71) Applicant: JAPAN AVIATION ELECTRONICS INDUSTRY, LIMITED, Tokyo (JP)

(72) Inventor: Osamu HASHIGUCHI, Tokyo (JP)

(73) Assignee: JAPAN AVIATION ELECTRONICS INDUSTRY, LIMITED, Tokyo (JP)

(21) Appl. No.: 18/926,727

(22) Filed: Oct. 25, 2024

(30) Foreign Application Priority Data
Dec. 13, 2023 (JP) 2023-210123

(51) Int. Cl. H01R 13/24; H01R 12/71; H01R 13/422

(52) U.S. Cl. CPC H01R 13/2435; H01R 12/714; H01R 13/422

(57) ABSTRACT

A contact module comprises a ground member made of metal, an insulation portion and a conductive portion. The ground member has a ground terminal and a terminal base each of which is at least partially resilient. The ground terminal has a ground contact point configured to be connected to a first object and a ground connection portion configured to be connected to a second object. The ground contact point is movable in a predetermined direction. The terminal base is formed with the insulation portion located thereon. The insulation portion is formed with the conductive portion located thereon. The terminal base, the insulation portion and the conductive portion form a signal terminal. The conductive portion has a signal contact point configured to be connected to the first object and a signal connection portion configured to be connected to the second object. The signal contact point is movable in the predetermined direction.

### CROSS REFERENCE TO RELATED APPLICATIONS

This application is based on and claims priority under 35 U.S.C. § 119 to Japanese Patent Application No. JP 2023-210123 filed Dec. 13, 2023, the content of which is incorporated herein in its entirety by reference.

### BACKGROUND OF THE INVENTION

This invention relates to a contact module of a connector configured to connect a first object and a second object to each other.

For example, this type of contact module is disclosed in JP2015-210886A (Patent Document 1), the content of which is incorporated herein by reference.

Patent Document 1 discloses a connector (not shown) configured to connect a board (not shown) and a flexible printed circuits (FPC) assembly (not shown) to each other, the board being a first object, the FPC assembly being a second object.

Referring to FIG. 17, the connector of Patent Document 1 comprises a contact module which includes a plurality of contacts 90. Each of the contacts 90 has a main portion 92, three extending portions (first terminals) 93 configured to be connected to the first object and three extending portions (second terminals) 94 configured to be connected to the second object. Each of the contacts 90 is formed with two layers which consist of a base portion 96 formed of a metal plate and an insulation layer 97 made of insulator. The insulation layers 97 of two of the first terminals 93 are formed with third layers, or ground lines (ground layers) 98, located thereon. The insulation layer 97 of a remaining one of the first terminals 93 is formed with another third layer, or a signal line (signal layer) 99, located thereon. Each of the ground layers 98 partially pierces the insulation layer 97 to be connected to the base portion 96. According to the aforementioned structure, the contact 90 can be formed with a microstrip line and a coplanar line.

The contact module of Patent Document 1 has the aforementioned three-layer structure. The base portion located at the lowermost layer and the ground layer located at the uppermost layer are connected to each other through the intermediate layer, or the insulation layer. Such a complex structure makes it difficult to form the contact module and tends to increase manufacturing cost. Moreover, contact reliability might be lowered because of problems such as poor contact between the ground layer and the base portion.

### SUMMARY OF THE INVENTION

It is therefore an object of the present invention to provide a contact module which has a simpler structure and higher contact reliability.

An aspect of the present invention provides a connector configured to connect a first object and a second object to each other. The connector comprises a contact module. The contact module comprises a ground member made of metal, an insulation portion and a conductive portion. The ground member has a ground terminal and a terminal base. Each of the ground terminal and the terminal base is at least partially resilient. The ground terminal has a ground contact point configured to be connected to the first object and a ground connection portion configured to be connected to the second object. The ground contact point is movable in a predetermined direction. The terminal base is formed with the insulation portion located thereon. The insulation portion is formed with the conductive portion located thereon. The terminal base, the insulation portion and the conductive portion form a signal terminal. The conductive portion has a signal contact point configured to be connected to the first object and a signal connection portion configured to be connected to the second object. The signal contact point is movable in the predetermined direction.

Another aspect of the present invention provides a contact module configured to be connected to a first object and a second object. The contact module comprises a ground member made of metal, an insulation portion and a conductive portion. The ground member has a ground terminal and a terminal base. Each of the ground terminal and the terminal base is at least partially resilient. The ground terminal has a ground contact point configured to be connected to the first object and a ground connection portion configured to be connected to the second object. The ground contact point is movable in a predetermined direction. The terminal base is formed with the insulation portion located thereon. The insulation portion is formed with the conductive portion located thereon. The terminal base, the insulation portion and the conductive portion form a signal terminal. The conductive portion has a signal contact point configured to be connected to the first object and a signal connection portion configured to be connected to the second object. The signal contact point is movable in the predetermined direction.

According to the contact module of an aspect of the present invention, a part of the ground member made of metal can be used as the ground terminal configured to be connected to a ground line of the first object and another ground line of the second object. The thus-formed ground terminal of an aspect of the present invention has a single-layer structure. Accordingly, the contact module can be relatively easily manufactured. In addition, the ground terminal can be reliably connected to the ground line of the first object and the ground line of the second object while problems such as poor contact are prevented. Moreover, the signal terminal of an aspect of the present invention is resiliently deformable using a spring force of the ground member made of metal. The signal terminal with this structure can be reliably connected to a signal line of the first object and another signal line of the second object. Thus, an aspect of the present invention provides a contact module which has a simpler structure and higher contact reliability.

An appreciation of the objectives of the present invention and a more complete understanding of its configuration may be had by studying the following description of the preferred embodiment and by referring to the accompanying drawings.

### BRIEF DESCRIPTION OF THE DRAWINGS

FIG. 1 is a perspective view showing a connector according to an embodiment of the present invention, wherein a part of the connector enclosed by dashed line is enlarged and illustrated.

FIG. 2 is a front view showing the connector of FIG. 1, wherein outlines of hidden passing holes are illustrated with dashed line.

FIG. 3 is a cross-sectional view showing the connector of FIG. 2, taken along line III-III, wherein a part of the connector enclosed by dashed line is enlarged and illustrated.

FIG. 4 is a cross-sectional view showing the connector of FIG. 2, taken along line IV-IV, wherein an outline of a lower surface of a first object and another outline of an upper surface of a second object in a process in which the connector is connected to the first object and the second object are illustrated with dashed line, and outlines of signal contacts under a state where the connector is connected to the first object and the second object are illustrated with dashed line.

FIG. 5 is a side view showing the connector of FIG. 1.

FIG. 6 is a front view showing the connector of FIG. 1 together with the first object and the second object, wherein the connector is connected to the first object and the second object, and outlines of the hidden passing holes are illustrated with dashed line.

FIG. 7 is a cross-sectional view showing the connector, the first object and the second object of FIG. 6, taken along line VII-VII.

FIG. 8 is a perspective view showing a contact module of the connector of FIG. 1.

FIG. 9 is another perspective view showing the contact module of FIG. 8.

FIG. 10 is a front view showing the contact module of FIG. 8, wherein imaginary boundaries of a belt-like portion are illustrated with dashed line.

FIG. 11 is a cross-sectional view showing the contact module of FIG. 10, taken along line XI-XI.

FIG. 12 is a cross-sectional view showing the contact module of FIG. 10, taken along line XII-XII, wherein two parts of the contact module each enclosed by dashed line are enlarged and illustrated.

FIG. 13 is a top view showing the contact module of FIG. 8.

FIG. 14 is a cross-sectional view showing the contact module of FIG. 13, taken along line XIV-XIV, wherein two parts of a signal terminal each enclosed by dashed line are enlarged and illustrated.

FIG. 15 is a view showing an example of a base member which is used to form the contact module of FIG. 8.

FIG. 16 is a view showing an intermediate member which is made by cutting the base member of FIG. 15.

FIG. 17 is a perspective view showing a part of a contact module of Patent Document 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

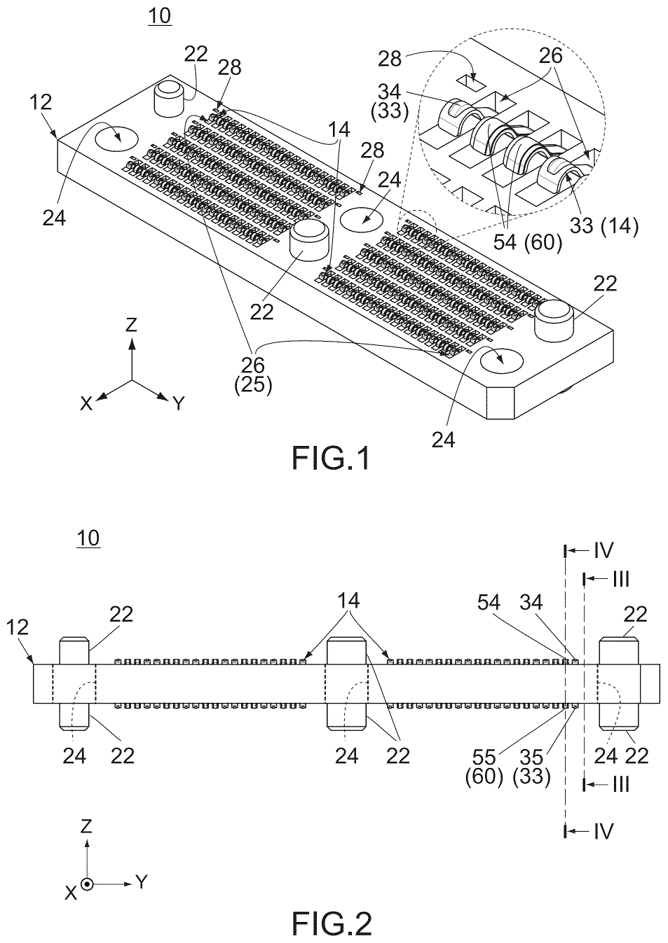

Referring to FIG. 1 together with FIG. 6, a connector 10 of an embodiment of the present invention is configured to connect a first object 82 and a second object 86 to each other. The first object 82 and the second object 86 of the present embodiment are configured to be attached and connected to the connector 10 so that the connector 10 is sandwiched and held therebetween in an up-down direction.

The up-down direction of the present embodiment is the Z-direction. In the present embodiment, “upward” means the positive Z-direction, and “downward” means the negative Z-direction. The words about positions such as the up-down direction do not indicate the absolute positional relation relative to the ground but merely indicate a relative positional relation shown in figures. For example, in the explanation of the present invention, a direction along which the connector 10, the first object 82 and the second object 86 connected to each other are arranged is defined as the up-down direction.

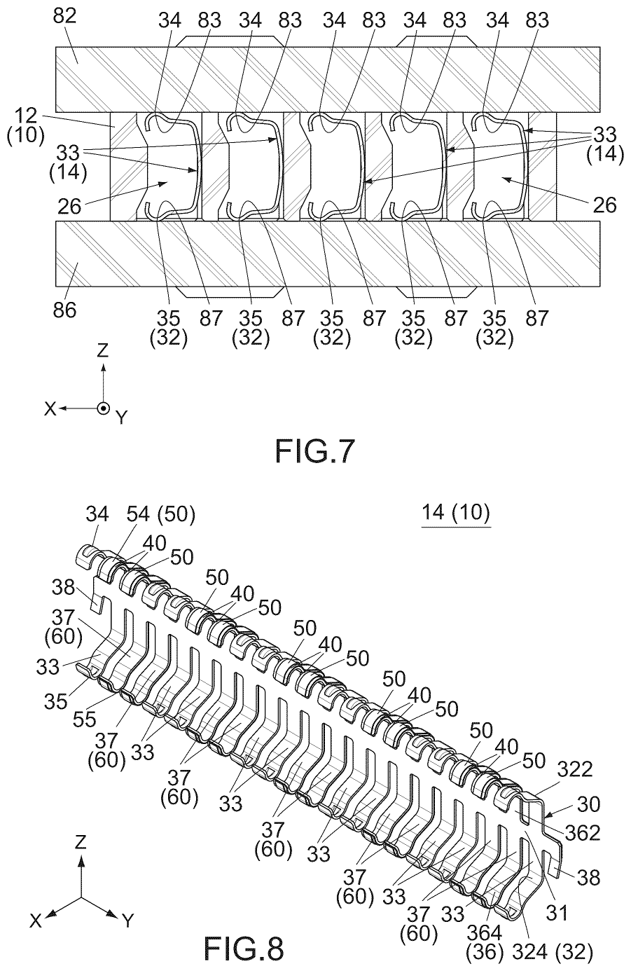

Referring to FIGS. 4 and 7, each of the first object 82 and the second object 86 of the present embodiment is a circuit board with various conductive patterns formed thereon and extends along a horizontal plane (XY-plane) perpendicular to the up-down direction. The connector 10 of the present embodiment is a so-called compression connector. The first object 82 and the second object 86, which are two circuit boards extending in parallel to each other, can be electrically connected with the connector 10 merely by pressing them against the connector 10.

For example, the first object 82 has a lower surface which is formed with a plurality of ground lines 83 each made of conductor and a plurality of signal lines 84 each made of conductor, and the second object 86 has an upper surface which is formed with a plurality of ground lines 87 each made of conductor and a plurality of signal lines 88 each made of conductor. Under a connected state where the connector 10 is connected to the first object 82 and the second object 86 as shown in FIG. 7, the ground lines 83 are electrically connected with the ground lines 87, respectively, and the signal lines 84 are electrically connected with the signal lines 88, respectively.

Referring to FIG. 6, each of the first object 82 and the second object 86 of the present embodiment has the aforementioned structure. However, the structure of each of the first object 82 and the second object 86 of the present invention can be variously modified.

For example, the second object 86 may extend along a vertical plane (YZ-plane) in parallel to the up-down direction. In this instance, the connector 10 may be fixed to the second object 86 via soldering, etc., and the first object 82 may be electrically connectable with the connector 10 merely by pressing the first object 82 against the connector 10.

For example, the connector 10 may be a so-called edge connector. In this instance, the first object 82 may extend along the YZ-plane. The thus-arranged first object 82 may have a lower end which is provided with a plurality of terminals. The connector 10 may be attached to the first object 82 so that the terminals of the lower end of the first object 82 are sandwiched and held by the connector 10 in the XY-plane. In this instance, the second object 86 may extend along the XY-plane or may extend along a plane intersecting with the XY-plane.

Referring to FIG. 1 together with FIG. 8, the connector 10 of the present embodiment comprises a holding member 12 made of insulator and a plurality of contact modules 14. Each of the contact modules 14 is held by the holding member 12. Referring to FIGS. 4 and 7, the ground lines 83 and the signal lines 84 of the first object 82 are electrically connected with the ground lines 87 and the signal lines 88 of the second object 86, respectively, via the contact modules 14 under the connected state. Thus, each of the contact modules 14 is configured to be connected to the first object 82 and the second object 86.

Referring to FIG. 1, the number of the contact modules 14 of the present embodiment is ten. These ten contact modules 14 are divided into two groups in a pitch direction perpendicular to the up-down direction. Five of the contact modules 14 of each group are arranged in a line in a front-rear direction perpendicular to both the up-down direction and the pitch direction. The pitch direction of the present embodiment is a lateral direction and the Y-direction. The front-rear direction of the present embodiment is the X-direction. In the present embodiment, “forward” means the positive X-direction, and “rearward” means the negative X-direction.

The connector 10 of the present embodiment comprises only the holding member 12 and the contact modules 14. However, the present invention is not limited thereto. For example, the connector 10 may further comprise another member in addition to the holding member 12 and the contact modules 14. The holding member 12 may be provided as necessary. In other words, the connector 10 may comprise only the contact modules 14. In this instance, only the contact modules 14 may work as the connector 10. The number of the contact modules 14 may be one, two or more regardless whether the connector 10 comprises the holding member 12 or not.

Hereafter, explanation will be made about one of the contact modules 14 of the present embodiment. The explanation described below is applicable to each of the contact modules 14.

Referring to FIG. 8 together with FIG. 1, the contact module 14 of the present embodiment can be used as a contact module of the connector 10. The contact module 14 of the present embodiment comprises a ground member 30 made of metal, a plurality of insulation portions 40 each made of insulator and a plurality of conductive portions 50 each made of conductor.

Referring to FIG. 10, the ground member 30 of the present embodiment is formed of a metal plate such as a copper alloy plate or a stainless-steel plate which is suitable for forming a spring. The ground member 30 of the present embodiment has a belt-like portion 31, a plurality of first springs 32, a plurality of second springs 36 and two held portions 38. Thus, the contact module 14 of the present embodiment has the belt-like portion 31, the first springs 32, the second springs 36 and the held portions 38. In the present embodiment, the number of the first springs 32 is ten, and the number of the second springs 36 is ten. The two held portions 38 are located at opposite ends of the ground member 30 in the pitch direction (Y-direction), respectively. However, the present invention is not limited thereto. For example, the number of the first springs 32 may be one, and the number of the second springs 36 may be one. The held portions 38 may be provided as necessary.

The belt-like portion 31 of the present embodiment is a belt-like part which has a constant size in the up-down direction. The belt-like portion 31 of the present embodiment has a flat-plate shape perpendicular to the front-rear direction. The belt-like portion 31 extends in the pitch direction. In detail, the belt-like portion 31 is located at the middle of the ground member 30 in the up-down direction and extends straight along the pitch direction between the opposite ends of the ground member in the pitch direction.

Each of the first springs 32 includes a first upper spring 322 and a first lower spring 324 each of which is resiliently deformable. Each of the first upper springs 322 extends upward from an upper edge of the belt-like portion 31. Each of the first lower springs 324 extends downward from a lower edge of the belt-like portion 31. The first upper spring 322 and the first lower spring 324 of each of the first springs 32 are located at positions same as each other in the pitch direction (Y-direction) and have sizes same as each other in the pitch direction.

According to the present embodiment, the first upper spring 322 and the first lower spring 324 of each of the first springs 32 have a mirror-symmetrical shape with respect to the XY-plane and have spring characteristics same as each other. However, the present invention is not limited thereto. For example, the first upper spring 322 and the first lower spring 324 may have an unsymmetrical shape with respect to the XY-plane.

Each of the second springs 36 includes a second upper spring 362 and a second lower spring 364 each of which is resiliently deformable. Each of the second upper springs 362 extends upward from the upper edge of the belt-like portion 31. Each of the second lower springs 364 extends downward from the lower edge of the belt-like portion 31. The second upper spring 362 and the second lower spring 364 of each of the second springs 36 are located at positions same as each other in the pitch direction (Y-direction) and have sizes same as each other in the pitch direction.

According to the present embodiment, the second upper spring 362 and the second lower spring 364 of each of the second springs 36 have a mirror-symmetrical shape with respect to the XY-plane and have spring characteristics same as each other. However, the present invention is not limited thereto. For example, the second upper spring 362 and the second lower spring 364 may have an unsymmetrical shape with respect to the XY-plane.

Each of the first springs 32 and the second springs 36 of the present embodiment is formed of two springs which are resiliently deformable independently from each other as described above and extends from the belt-like portion 31 in a perpendicular direction perpendicular to the pitch direction (Y-direction). The perpendicular direction of the present embodiment is the up-down direction and the Z-direction. However, the present invention is not limited thereto. For example, the perpendicular direction may intersect with the up-down direction.

The first springs 32 and the second springs 36 of the present embodiment are arranged in a line in the pitch direction (Y-direction) with regular intervals. The first springs 32 and the second springs 36 of the present embodiment are divided into five sets. Each set consists of two of the first springs 32 and two of the second springs 36. The two second springs 36 of each set are adjacent to each other in the pitch direction. The two first springs 32 of each set are located at opposite sides of the two second springs 36 in the pitch direction, respectively. The first springs 32 and the second springs 36 of the present embodiment are arranged as described above. However, the present invention is not limited thereto. The arrangement of the first springs 32 and the second springs 36 can be modified as necessary.

Referring to FIG. 8, each of the held portions 38 of the present embodiment is a metal piece oblique to the front-rear direction. Each of the held portions 38 extends forward and downward from the lower edge of the belt-like portion 31. Each of the held portions 38 has an initial shape as described above and is resiliently deformable into a shape which is perpendicular to the front-rear direction. Each of the thus-resiliently-deformed held portions 38 has a force which urges the held portion 38 to return to its initial shape. Each of the held portions 38 of the present embodiment has the aforementioned structure. However, the structure of each of the held portions 38 can be modified as necessary.

Explaining the structure of the ground member 30 of the present embodiment from another viewpoint, the ground member 30 has a plurality of ground terminals 33 and a plurality of terminal bases 37. Each of the ground terminals 33 of the present embodiment is formed of the first spring 32 and a part of the belt-like portion 31 which is located between the first upper spring 322 and the first lower spring 324. Thus, each of the first springs 32 forms at least a part of the ground terminal 33. Each of the terminal bases 37 of the present embodiment is formed of the second spring 36 and a part of the belt-like portion 31 which is located between the second upper spring 362 and the second lower spring 364. Thus, each of the second springs 36 forms at least a part of the terminal base 37. Each of the ground terminals 33 and the terminal bases 37 is formed as described above and is at least partially resilient.

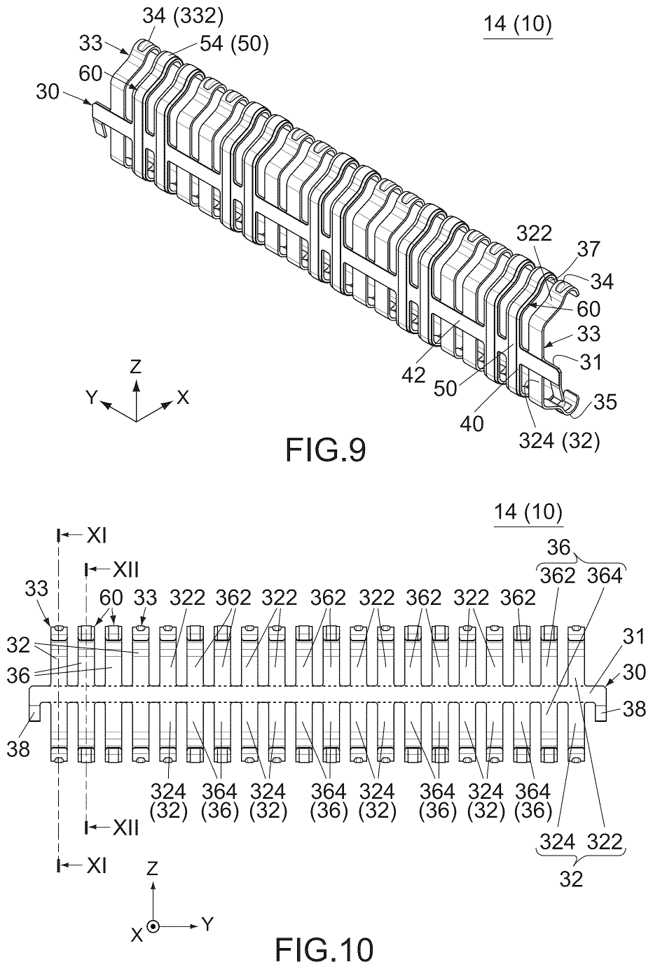

Referring to FIG. 9 together with FIG. 8, the terminal bases 37 are formed with the insulation portions 40 located thereon, respectively. Thus, the number of the insulation portions 40 is equal to the number of the terminal bases 37, and the insulation portions 40 correspond to the terminal bases 37, respectively. The insulation portions 40 are formed with the conductive portions 50 located thereon, respectively. Thus, the number of the conductive portions 50 is equal to the number of the insulation portions 40, and the conductive portions 50 correspond to the insulation portions 40, respectively. Each of the terminal bases 37 forms one signal terminal 60 together with the corresponding insulation portion 40 and the corresponding conductive portion 50. In other words, each of the terminal bases 37, the corresponding insulation portion 40 and the corresponding conductive portion 50 form the signal terminal 60. Each of the signal terminals 60 has a three-layer structure which consist of the terminal base 37, the insulation portion 40 and the conductive portion 50.

According to the present embodiment, the insulation portion 40 of each of the signal terminals 60 completely covers the terminal base 37. The conductive portion 50 of each of the signal terminals 60 covers only a middle part of the insulation portion 40 in the pitch direction while completely covering the insulation portion 40 in a direction along which the signal terminal 60 extends. According to this structure, the signal terminal 60 can have a spring force of the terminal base 37 while the conductive portion 50 and the terminal base 37 are reliably insulated from each other. However, the present invention is not limited thereto. For example, the insulation portion 40 may be formed only between the conductive portion 50 and the terminal base 37.

Referring to FIG. 7 together with FIG. 4, under the connected state where the connector 10 is connected to the first object 82 and the second object 86 as shown in FIG. 7, each of the ground terminals 33 is connected to the ground line 83 and the ground line 87 and has a ground potential, and each of the signal terminals 60 is connected to the signal line 84 and the signal line 88 and transmit signals between the first object 82 and the second object 86.

Referring to FIG. 8, the ground terminals 33 and the signal terminals 60 are formed in a comb-like structure and are arranged in the pitch direction (Y-direction). In detail, the ground terminals 33 and the signal terminals 60 are arranged in a line with regular intervals in the pitch direction and form a single terminal row.

The ground terminals 33 and the signal terminals 60 of the present embodiment are divided into five sets. Each set consists of two of the ground terminals 33 and two of the signal terminals 60. The two signal terminals 60 of each set are adjacent to each other in the pitch direction. The two ground terminals 33 of each set are located at opposite sides of the two signal terminals 60 in the pitch direction, respectively. However, the present invention is not limited thereto. For example, the arrangement of the ground terminals 33 and the signal terminals 60 can be modified in accordance with the first object 82 (see FIG. 7) and the second object 86 (see FIG. 7) and can be modified in consideration of impedance matching. The number of ground terminals 33 may be one, and the number of the signal terminals 60 may be one.

Referring to FIG. 9, the contact module 14 of the present embodiment comprises a belt-like insulation portion 42 made of insulator. The belt-like insulation portion 42 is formed on the belt-like portion 31 of the ground member 30 and extends straight along the pitch direction between the opposite ends of the belt-like portion 31 in the pitch direction (Y-direction). The thus-formed belt-like insulation portion 42 includes middle parts of all the insulation portions 40 in the up-down direction. The contact module 14 of the present embodiment is provided with the aforementioned belt-like insulation portion 42. However, the present invention is not limited thereto. The belt-like insulation portion 42 may be provided as necessary, provided that the contact module 14 comprises the insulation portions 40.

Hereafter, explanation will be made about the holding member 12 (see FIG. 1) of the present embodiment.

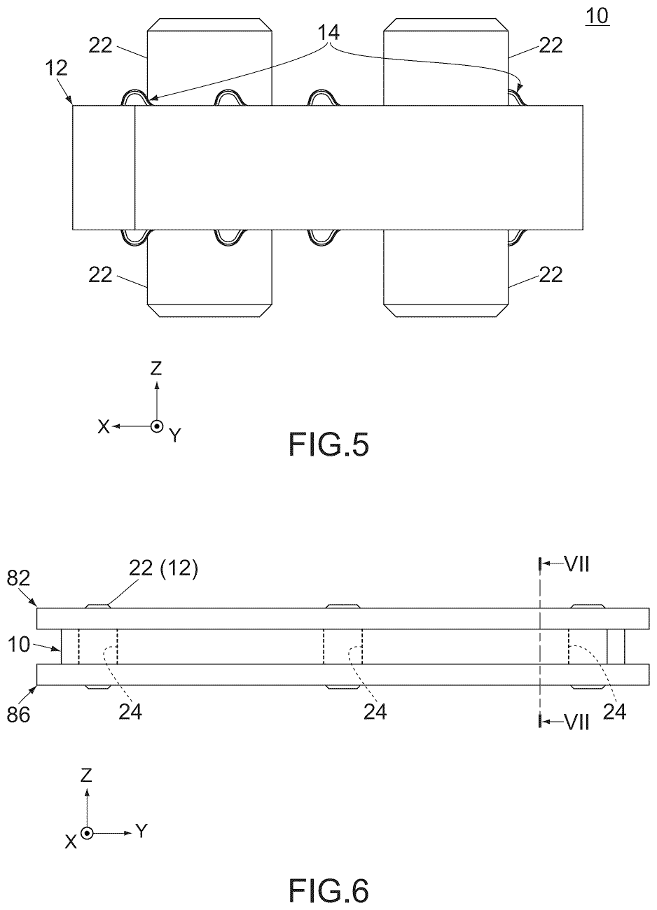

As shown in FIGS. 1, 2 and 5, the holding member 12 of the present embodiment has a rectangular flat-plate shape in parallel to the XY-plane. The thus-shaped holding member 12 has an upper surface and a lower surface each of which extends in parallel to the XY-plane. The holding member 12 has six positioning projections 22. Three of the positioning projections 22 extend upward from the upper surface of the holding member 12. Remaining three of the positioning projections 22 extend downward from the lower surface of the holding member 12. In addition, the holding member 12 is formed with three passing holes 24. Each of the passing holes 24 passes through the holding member 12 in the up-down direction and opens at the upper surface and the lower surface of the holding member 12.

Referring to FIG. 2 together with FIG. 6, the first object 82 of the present embodiment is configured to be attached to the connector 10 under a state where the three upper positioning projections 22 position the first object 82 relative to the connector 10 in the XY-plane. The second object 86 of the present embodiment is configured to be attached to the connector 10 under a state where the three lower positioning projections 22 position the second object 86 relative to the connector 10 in the XY-plane. Referring to FIG. 1 together with FIG. 6, the first object 82 and the second object 86 attached to the connector 10 are configured to be fixed to the connector 10 with screws which are screwed into screw holes (not shown) of the first object 82 and the second object 86 via the passing holes 24.

The holding member 12 of the present embodiment is formed with the positioning projections 22 and the passing holes 24 which work as described above. However, the structure of the holding member 12 can be variously modified in accordance with the first object 82 and the second object 86. For example, the positioning projections 22 and the passing holes 24 may be formed as necessary.

Referring to FIG. 1, the holding member 12 of the present embodiment is provided with ten holding sections 25 which correspond to the ten contact modules 14, respectively. Each of the contact modules 14 is accommodated and held in the corresponding holding section 25. The number of the holding sections 25 may be equal to the number of the contact modules 14. For example, only one of the holding sections 25 may be provided in an instance in which the connector 10 comprises only one of the contact modules 14.

Hereafter, explanation will be made about one of the holding sections 25 of the present embodiment. The explanation described below is applicable to each of the holding sections 25.

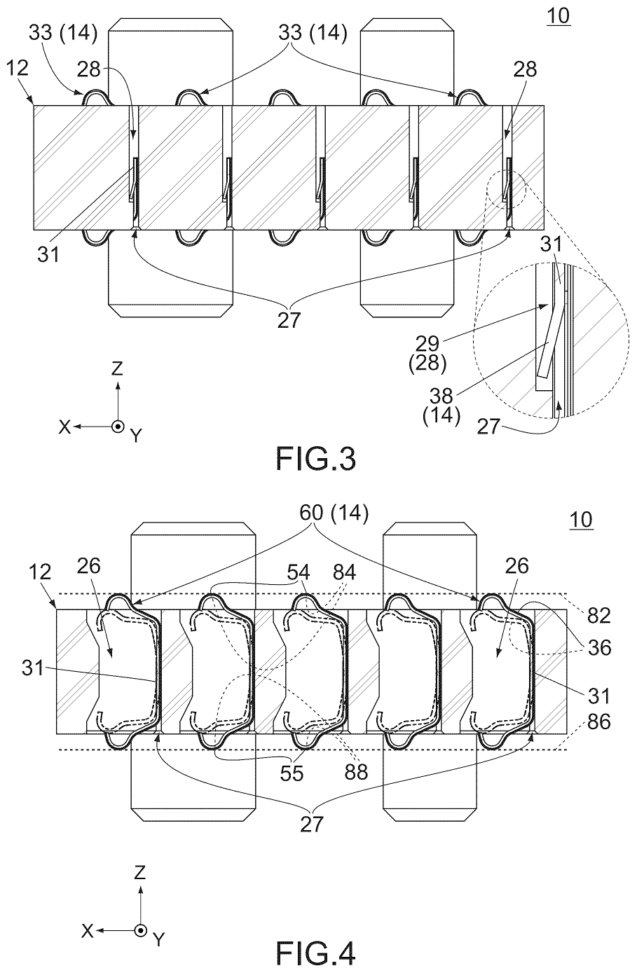

Referring to FIG. 1 together with FIGS. 3 and 4, the holding section 25 is formed with a plurality of accommodation portions 26, a groove 27 and two holding holes 28. Each of the accommodation portions 26, the groove 27 and the holding holes 28 is a space formed in the holding member 12.

The accommodation portions 26 are provided so as to correspond to the ground terminals 33 and the signal terminals 60 of the contact module 14, respectively. The accommodation portions 26 are arranged in a line in the pitch direction (Y-direction) and forms an accommodation row. Each of the accommodation portions 26 opens upward and downward. The holding holes 28 are provided so as to correspond to the held portions 38 of the contact module 14, respectively, and are located at opposite ends of the accommodation row in the pitch direction, respectively. Each of the holding holes 28 opens upward. The groove 27 is provided so as to correspond to the belt-like portion 31 of the contact module 14 and extends between the two holding holes 28 along the pitch direction. The groove 27 opens only downward.

Referring to FIG. 3, each of the holding holes 28 has a holding portion 29. Thus, the holding member 12 has the holding portions 29. Each of the holding portions 29 is a front part of the holding hole 28 and is recessed forward from a rear part of the holding hole 28. Each of the holding portions 29 is a space with a bottom. In other words, each of the holding portions 29 opens only upward. The rear part of each of the holding holes 28 communicates with the groove 27 in the up-down direction and opens downward via the groove 27.

The holding section 25 (see FIG. 1) of the present embodiment has the aforementioned structure. However, the structure of the holding section 25 is not specifically limited, provided that the holding section 25 can hold the contact module 14.

Referring to FIG. 8 together with FIGS. 3 and 4, the contact module 14 of the present embodiment is attached to and held by the holding member 12 as described below.

Firstly, the belt-like portion 31 of the contact module 14 is inserted into the groove 27 of the holding member 12 from below. Meanwhile, the upper parts of the ground terminals 33 and the signal terminals 60 of the contact module 14 are received in the accommodation portions 26, respectively. Each of the held portions 38 of the contact module 14 is received in the groove 27 under a state where it is resiliently deformed so as to extend along the YZ-plane. When the contact module 14 is continuously moved upward, each of the held portions 38 is located in the holding hole 28 through the groove 27. Each of the thus-located held portions 38 returns to its initial shape, and thereby the lower end of each of the held portions 38 is located just over the bottom of the holding portion 29. At that time, the contact module 14 is attached to the holding member 12.

The held portions 38 are held by the holding portion 29 when the contact module 14 is attached to the holding member 12. More specifically, the held portions 38 are brought into abutment with the bottoms of the holding portions 29 upon an attempt of moving the contact module 14 downward. The belt-like portion 31 is brought into abutment with the ceiling of the groove 27 upon another attempt of further moving the contact module 14 upward.

As described above, each of the held portions 38 of the present embodiment works as a lance which prevents the removal of the contact module 14. According to the present embodiment, the holding member 12 can more securely hold the contact module 14 because the two held portions 38 are provided on opposite ends of the contact module 14 in the pitch direction (Y-direction), respectively. However, the present invention is not limited thereto. For example, the number of the held portions 38 may be one. Each of the held portions 38 is not limited to a lance. For example, each of the held portions 38 may be a press-fit portion. The contact module 14 may be soldered to the second object 86 (see FIG. 6) as described later. In this instance, the holding portions 29 and the held portions 38 do not need to be provided.

Referring to FIG. 4 together with FIG. 7, each of the ground terminals 33 and the signal terminals 60 is located in the corresponding accommodation portion 26 when the contact module 14 is held by the holding member 12. Each of the ground terminals 33 and the signal terminals 60 has an upper end which projects upward from the accommodation portion 26 and a lower end which projects downward from the accommodation portion 26. Each of the accommodation portions 26 has a size which enables a resilient deformation of the corresponding ground terminal 33 or the corresponding signal terminal 60. More specifically, each of the first springs 32 of the ground terminals 33 and the second springs 36 of the signal terminals 60 is resiliently deformable in the accommodation portion 26 without being brought into contact with an inner wall surface of the accommodation portion 26.

Hereafter, further specific explanation will be made about one of the ground terminals 33 and one of the signal terminals 60 of the present embodiment. The explanation described below is applicable to each of the ground terminals 33 and each of the signal terminals 60.

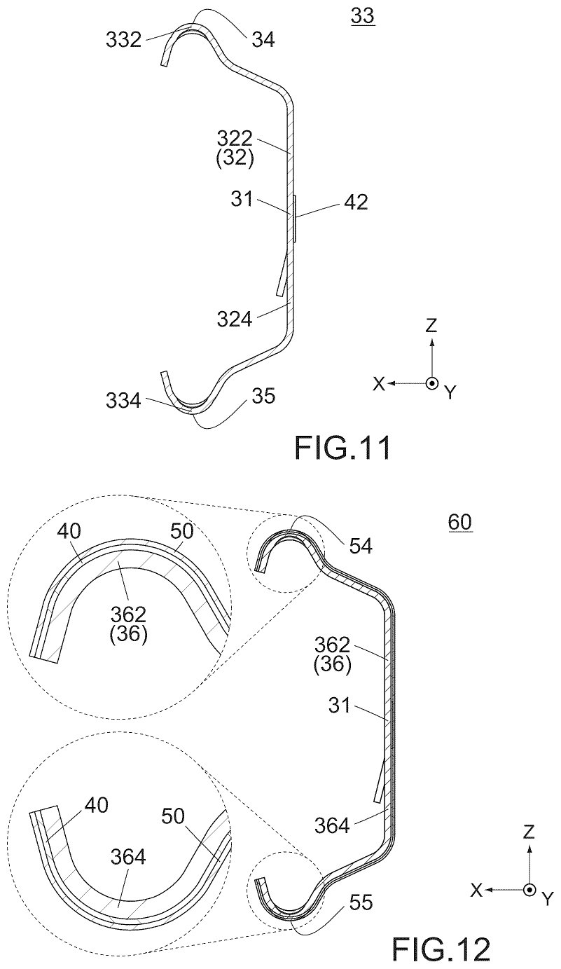

Referring to FIG. 11 together with FIG. 7, the ground terminal 33 of the present embodiment is formed of only a single metal piece. The ground terminal 33 has a ground contact point 34 configured to be connected to the first object 82 and a ground connection portion 35 configured to be connected to the second object 86. Each of the ground contact point 34 and the ground connection portion 35 is gold plated, for example. Each of the ground contact point 34 and the ground connection portion 35 is movable in a predetermined direction. The predetermined direction of the present embodiment is the up-down direction and the Z-direction. However, the present invention is not limited thereto as described later.

As shown in FIG. 11, each of the ground contact point 34 and the ground connection portion 35 of the present embodiment is provided on the first spring 32. In detail, the ground contact point 34 is provided on the first upper spring 322, and the ground connection portion 35 is provided on the first lower spring 324. The ground contact point 34 is located at the upper end of the ground terminal 33 and is vertically movable in accordance with resilient deformation of the first upper spring 322. The ground connection portion 35 is located at the lower end of the ground terminal 33 and is vertically movable in accordance with resilient deformation of the first lower spring 324. The ground contact point 34 and the ground connection portion 35 are movable independently from each other.

According to the present embodiment, the ground contact point 34 is formed by bending an upper end part of the first upper spring 322 into an arc-like shape which protrudes upward, and the ground connection portion 35 is formed by bending a lower end part of the first lower spring 324 into another arc-like shape which protrudes downward. However, the formation method of the ground contact point 34 and the ground connection portion 35 of the present invention is not specifically limited.

Referring to FIG. 12 together with FIG. 4, the signal terminal 60 of the present embodiment has three layers which consist of a first layer, a second layer and a third layer. The first layer is formed of a single metal piece which includes the second spring 36 and a part of the belt-like portion 31. The second layer is formed of the insulation portion 40. The third layer is formed of the conductive portion 50. The conductive portion 50 has a signal contact point 54 configured to be connected to the first object 82 and a signal connection portion 55 configured to be connected to the second object 86. Each of the signal contact point 54 and the signal connection portion 55 is gold plated, for example. Each of the signal contact point 54 and the signal connection portion 55 is movable in the predetermined direction (Z-direction).

As shown in FIG. 12, each of the signal contact point 54 and the signal connection portion 55 of the present embodiment is supported by the second spring 36 via the insulation portion 40. In detail, the signal contact point 54 is supported by the second upper spring 362 via the insulation portion 40, and the signal connection portion 55 is supported by the second lower spring 364 via the insulation portion 40. The signal contact point 54 is located at the upper end of the signal terminal 60 and is vertically movable in accordance with resilient deformation of the second upper spring 362. The signal connection portion 55 is located at the lower end of the signal terminal 60 and is vertically movable in accordance with resilient deformation of the second lower spring 364. The signal contact point 54 and the signal connection portion 55 are movable independently from each other.

According to the present embodiment, the signal contact point 54 is formed by bending an upper end part of the second upper spring 362 into an arc-like shape which protrudes upward, and the signal connection portion 55 is formed by bending a lower end part of the second lower spring 364 into another arc-like shape which protrudes downward. However, the formation method of the signal contact point 54 and the signal connection portion 55 of the present invention is not specifically limited.

Referring to FIG. 8 together with FIGS. 4 and 7, under the connected state where the connector 10 is connected to the first object 82 and the second object 86 as shown in FIG. 7, the ground contact point 34 and the ground connection portion 35 of the ground terminal 33 are pressed against and brought into contact with the ground line 83 of the first object 82 and the ground line 87 of the second object 86, respectively, and the signal contact point 54 and the signal connection portion 55 of the signal terminal 60 are pressed against and brought into contact with the signal line 84 of the first object 82 and the signal line 88 of the second object 86, respectively.

As described above, according to the contact module 14 of the present embodiment, a part of the ground member 30 made of metal can be used as the ground terminal 33 configured to be connected to the ground line 83 of the first object 82 and the ground line 87 of the second object 86. The thus-formed ground terminal 33 of the present embodiment has a single-layer structure. Accordingly, the contact module 14 can be relatively easily manufactured. Moreover, according to the present embodiment, the existing complex structure, in which a ground layer pierces an insulation layer so as to be connected to a base made of metal, is unnecessary. Accordingly, the ground terminal 33 can be reliably connected to the ground line 83 of the first object 82 and the ground line 87 of the second object 86 with sufficient contact pressure while problems such as poor contact of the ground terminal 33 are prevented.

The signal terminal 60 of the present embodiment is resiliently deformable using the spring force of the ground member 30 made of metal. The signal terminal 60 with this structure can be reliably connected to the signal line 84 of the first object 82 and the signal line 88 of the second object 86 with sufficient contact pressure. Thus, the present embodiment provides the contact module 14 which has a simpler structure and higher contact reliability.

According to the present embodiment, the contact pressure applied to the ground line 83 of the first object 82 can be adjusted by changing a size of a part of the ground terminal 33 which projects beyond the upper surface of the holding member 12, and the contact pressure applied to the ground line 87 of the second object 86 can be adjusted by changing a size of a part of the ground terminal 33 which projects beyond the lower surface of the holding member 12. Similarly, the contact pressure applied to the signal line 84 of the first object 82 can be adjusted by changing a size of a part of the signal terminal 60 which projects beyond the upper surface of the holding member 12, and the contact pressure applied to the signal line 88 of the second object 86 can be adjusted by changing a size of a part of the signal terminal 60 which projects beyond the lower surface of the holding member 12.

According to the present embodiment, the ground member 30 has a ground potential under the connected state, and thereby the signal terminal 60 forms a microstrip line. According to the present embodiment, the conductive portion 50 of the signal terminal 60 is located at a position different from that of the ground terminal 33 in the XZ-plane (perpendicular plane) except for the signal contact point 54 and the signal connection portion 55. However, the ground terminal 33 with a ground potential and the signal terminal 60 through which signals flow are adjacent to each other and extend in parallel to each other. These structures can improve signal transmission characteristics of the contact module 14.

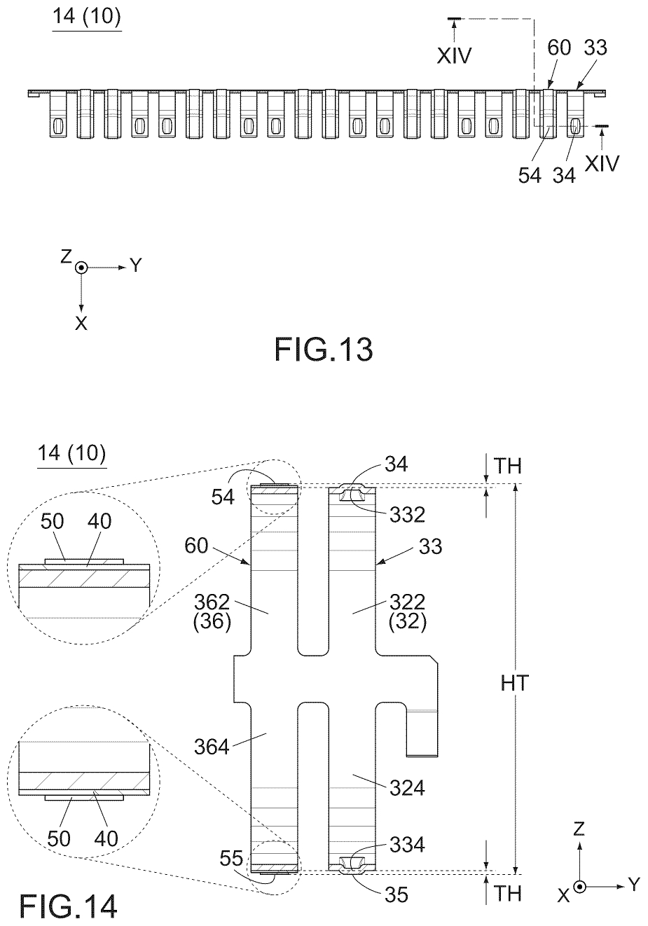

Referring to FIG. 8 together with FIG. 13, the ground contact point 34 and the signal contact point 54 of the present embodiment are located at positions same as each other in the front-rear direction perpendicular to both the pitch direction (Y-direction) and the perpendicular direction (Z-direction). Similarly, the ground connection portion 35 and the signal connection portion 55 are located at positions same as each other in the front-rear direction. According to this arrangement, the ground terminal 33 and the signal terminal 60 can be easily arranged in parallel to each other under the connected state. However, the arrangement of the ground contact point 34, the signal contact point 54, the ground connection portion 35 and the signal connection portion 55 can be modified as necessary.

Referring to FIGS. 4 and 7, each of the ground contact point 34, the signal contact point 54, the ground connection portion 35 and the signal connection portion 55 of the present embodiment is movable along the predetermined direction which is the up-down direction. In other words, each of the ground contact point 34 and the signal contact point 54 is vertically movable. Similarly, each of the ground connection portion 35 and the signal connection portion 55 is vertically movable. Under a state where the connector 10 is vertically sandwiched between the first object 82 and the second object 86, the ground contact point 34 and the signal contact point 54 are pressed against and connected to the first object 82, and the ground connection portion 35 and the signal connection portion 55 are pressed against and connected to the second object 86. Meanwhile, the first spring 32 and the second spring 36 are resiliently deformed, and thereby each of the ground terminal 33 and the signal terminal 60 is completely received in the corresponding accommodation portion 26.

The contact module 14 of the present embodiment is electrically connectable with the first object 82 and the second object 86 without being soldered. However, the present invention is not limited thereto. The connection method of the contact module 14 to the first object 82 and the second object 86 can be variously modified as described below.

For example, the ground connection portion 35 and the signal connection portion 55 may be soldered to the ground line 87 and the signal line 88 of the second object 86, respectively. The first object 82 may be pressed downward against the contact module 14 which is soldered to and fixed on the second object 86 as described above. In an instance in which the connector 10 is an edge connector, each of the ground contact point 34 and the signal contact point 54 may be movable in the front-rear direction. In other words, the predetermined direction may be the front-rear direction perpendicular to the up-down direction. In this instance, the first object 82 may extend along the YZ-plane, and each of the ground contact point 34 and the signal contact point 54 may be pressed against and connected to the first object 82 along the front-rear direction.

Referring to FIG. 14 together with FIGS. 4 and 7, the ground contact point 34 and the signal contact point 54 of the present embodiment are located at positions same as each other in the predetermined direction (Z-direction). According to this arrangement, a movement distance of the ground contact point 34 can be made equal to a movement distance of the signal contact point 54 in a process in which the connector 10 is connected to the first object 82, and thereby the ground contact point 34 and the signal contact point 54 can be connected to the first object 82 with contact pressures similar to each other. Similarly, the ground connection portion 35 and the signal connection portion 55 of the present embodiment are located at positions same as each other in the predetermined direction (Z-direction). According to this arrangement, the ground connection portion 35 and the signal connection portion 55 can be connected to the second object 86 with contact pressures similar to each other.

However, the arrangement of the ground contact point 34, the signal contact point 54, the ground connection portion 35 and the signal connection portion 55 can be variously modified in accordance with the first object 82 and the second object 86. For example, when each of the ground contact point 34 and the signal contact point 54 is pressed against the first object 82 along the front-rear direction, the ground contact point 34 and the signal contact point 54 may be located at positions same as each other in the predetermined direction (X-direction).

The ground terminal 33 of the present embodiment has a protruding portion 332. The protruding portion 332 protrudes in the predetermined direction (Z-direction) and partially works as the ground contact point 34. In detail, the protruding portion 332 has a size same as a total thickness TH of the insulation portion 40 and the conductive portion 50 of the signal terminal 60 in the predetermined direction.

According to the present embodiment, the protruding portion 332 is formed on the ground terminal 33 as describe above. Accordingly, the ground contact point 34 and the signal contact point 54 can be arranged at positions same as each other in the predetermined direction while an upper part of the first upper spring 322 is bent even in the same way as another upper part of the second upper spring 362. However, the present invention is not limited thereto. For example, the ground contact point 34 and the signal contact point 54 may be arranged at positions same as each other in the predetermined direction while the upper part of the first upper spring 322 is bent in a different way from the upper part of the second upper spring 362. In this instance, the protruding portion 332 does not need to be formed.

The ground terminal 33 of the present embodiment has a protruding portion 334 in addition to the protruding portion 332. The protruding portion 334 protrudes in the predetermined direction (Z-direction) and partially works as the ground connection portion 35. In detail, the protruding portion 334 has a size same as the total thickness TH of the insulation portion 40 and the conductive portion 50 of the signal terminal 60 in the predetermined direction similarly to the protruding portion 332. However, the present invention is not limited thereto. The forming method of the ground connection portion 35 can be modified similarly to that of the ground contact point 34.

The contact module 14 of the present embodiment can be manufactured as described below.

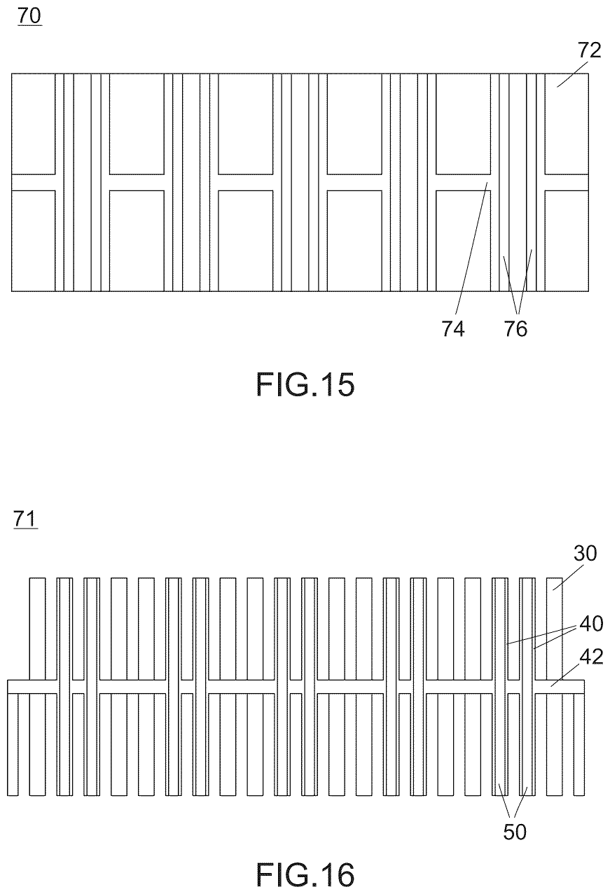

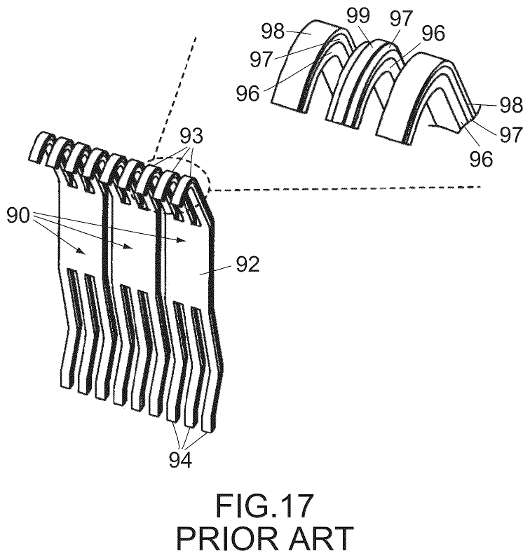

Referring to FIG. 15, firstly, a base member 70 is made. In detail, firstly, a metal plate 72 of a rectangular shape is made. Then, the metal plate 72 is formed with an insulation member 74 located thereon. Then, the insulation member 74 is formed with a conductive member 76 located thereon. Referring to FIGS. 15 and 16, then, the base member 70 is cut so that an intermediate member 71 is formed. The intermediate member 71 is formed with the ground member 30, a plurality of the insulation portions 40, the belt-like insulation portion 42 and a plurality of the conductive portions 50. Referring to FIG. 16 together with FIG. 8, then, a process such as bending is applied to the intermediate member 71 so that the contact module 14 is manufactured. The aforementioned manufacture method enables a simple and simultaneous manufacture of a large number of the ground terminals 33 and a large number of the signal terminals 60 of the contact module 14. However, the aforementioned manufacture method is only an example, and the manufacture method of the contact module 14 is not specifically limited.

What is claimed is:

1. A connector configured to connect a first object and a second object to each other, wherein:
the connector comprises a contact module;
the contact module comprises a ground member made of metal, an insulation portion and a conductive portion;
the ground member has a ground terminal and a terminal base;
each of the ground terminal and the terminal base is at least partially resilient;
the ground terminal has a ground contact point configured to be connected to the first object and a ground connection portion configured to be connected to the second object;
the ground contact point is movable in a predetermined direction;
the terminal base is formed with the insulation portion located thereon;
the insulation portion is formed with the conductive portion located thereon;
the terminal base, the insulation portion and the conductive portion form a signal terminal;
the conductive portion has a signal contact point configured to be connected to the first object and a signal connection portion configured to be connected to the second object; and
the signal contact point is movable in the predetermined direction.

2. The connector as recited in claim 1, wherein the ground contact point and the signal contact point are located at positions same as each other in the predetermined direction.

3. The connector as recited in claim 2, wherein:
the ground terminal has a protruding portion; and
the protruding portion protrudes in the predetermined direction and partially works as the ground contact point.

4. The connector as recited in claim 1, wherein:
the ground terminal and the signal terminal are arranged in a pitch direction;
the ground member has a belt-like portion, a first spring and a second spring;
the belt-like portion extends in the pitch direction;
each of the first spring and the second spring extends from the belt-like portion in a perpendicular direction perpendicular to the pitch direction;
the first spring forms at least a part of the ground terminal;
the ground contact point is provided on the first spring;
the second spring forms at least a part of the terminal base;
the signal contact point is supported by the second spring via the insulation portion; and
the ground contact point and the signal contact point are located at positions same as each other in a direction perpendicular to both the pitch direction and the perpendicular direction.

5. The connector as recited in claim 1, wherein:
the connector comprises a holding member;
the holding member has a holding portion;
the contact module has a held portion; and
the held portion is held by the holding portion.

6. The connector as recited in claim 5, wherein:
the predetermined direction is an up-down direction;
each of the ground contact point and the signal contact point is vertically movable; and
under a state where the connector is vertically sandwiched between the first object and the second object, the ground contact point and the signal contact point are pressed against and connected to the first object, and the ground connection portion and the signal connection portion are pressed against and connected to the second object.

7. A contact module configured to be connected to a first object and a second object, wherein:
the contact module comprises a ground member made of metal, an insulation portion and a conductive portion;
the ground member has a ground terminal and a terminal base;
each of the ground terminal and the terminal base is at least partially resilient;
the ground terminal has a ground contact point configured to be connected to the first object and a ground connection portion configured to be connected to the second object;
the ground contact point is movable in a predetermined direction;
the terminal base is formed with the insulation portion located thereon;
the insulation portion is formed with the conductive portion located thereon;
the terminal base, the insulation portion and the conductive portion form a signal terminal;
the conductive portion has a signal contact point configured to be connected to the first object and a signal connection portion configured to be connected to the second object; and
the signal contact point is movable in the predetermined direction.
